(19) United States
(12) Patent Application Publication
(10) Pub. No.: US 2011/0228749 A1
(43) Pub. Date: Sep. 22, 2011

(54) METHODS AND APPARATUS FOR SUPPORTING DATA FLOWS OVER MULTIPLE RADIO PROTOCOLS

(75) Inventors: Mohammad Hossein Taghavi Nasrabadi, San Diego, CA (US); Santosh Paul Abraham, San Diego, CA (US); Hemanth Sampath, San Diego, CA (US); Avinash Jain, San Diego, CA (US)

(73) Assignee: QUALCOMM Incorporated, San Diego, CA (US)

(21) Appl. No.: 12/885,288

(22) Filed: Sep. 17, 2010

Related U.S. Application Data
(60) Provisional application No. 61/262,835, filed on Nov. 19, 2009.
(60) Provisional application No. 61/300,213, filed on Feb. 1, 2010.

(51) Int. Cl. H04W 84/02

(52) U.S. Cl. 370/338; 370/328

(57) ABSTRACT

A method to seamlessly support data flows over multiple networks using different radio protocols is provided. The method may include supporting a data flow over a wireless link using a first radio protocol, enabling a second radio protocol for the data flow, based on one or more parameters, selecting at least one of the first radio protocol or the second radio protocol to support the data flow over the wireless link, while maintaining the data flow over the wireless link, and communicating the data flow over the wireless link using the selected at least one of the first radio protocol or the second radio protocol.

### CROSS-REFERENCE TO RELATED APPLICATION(S)

The present application for patent claims priority to Provisional Application No. 61/262,835, entitled “METHODS AND APPARATUS FOR SUPPORTING DATA FLOWS OVER MULTIPLE RADIO PROTOCOLS,” filed Nov. 19, 2009 with attorney docket number 100309P1, and Provisional Application No. 61/300,213, entitled “METHODS AND APPARATUS FOR SUPPORTING DATA FLOWS OVER MULTIPLE RADIO PROTOCOLS,” filed Feb. 1, 2010 with attorney docket number 100309P2, the contents of which are expressly incorporated by reference herein.

### BACKGROUND

1. Field of the Invention

The present disclosure relates generally to communication systems, and more particularly, to seamlessly support data flows over multiple networks using different radio protocols.

2. Relevant Background

In order to address the issue of increasing bandwidth requirements that are demanded for wireless communications systems, different schemes are being developed to allow multiple user terminals to communicate by sharing the channel resources while achieving high data throughputs. Multiple Input or Multiple Output (MIMO) technology represents one such approach that has recently emerged as a popular technique for the next generation communication systems. MIMO technology has been adopted in several emerging wireless communications standards such as the Institute of Electrical Engineers (IEEE) 802.11 standard. IEEE 802.11 denotes a set of Wireless Local Area Network (WLAN) air interface standards developed by the IEEE 802.11 committee for short-range communications (e.g., tens of meters to a few hundred meters). For example, 802.11 ad/ac/a/b/g/n.

Generally, wireless communications systems specified by the IEEE 802.11 standard have a central entity, such as an access point (AP)/point coordination function (PCF) that manages communications between different devices, also called stations (STAs). Having a central entity may simplify design of communication protocols. Further, although any device capable of transmitting a beacon signal may serve as an AP, for an AP to be effective it may have to have a good link quality to all STAs in a network. At high frequencies, where signal attenuation may be relatively severe, communications may be directional in nature and may use beamforming (e.g., beam training) to increase gains. As such, an AP may stratify the following responsibilities to be effective. The AP may have a large sector bound (e.g., a wide steering capability). The AP may have a large beamforming gain (e.g., multiple antennas). The AP may be mounted so that a line of sight path exists to most areas in a network, such as on a ceiling. The AP may use a steady power supply for periodic beacon transmissions and other management functions.

Mobile wireless communications devices (WCD) (e.g., laptops, smartphones, etc.) may have comparatively reduced capabilities to that of a traditional AP due to factors such as cost, power, form factor, etc. For example, antenna steering capability may be limited to a small sector bound, available power may be limited, location may be variable, etc. Even with these limitations, WCDs may be asked to perform as APs to form peer-to-peer networks for various purposes, such as side-loading, file sharing, etc.

In some wireless communications systems, WCDs may be equipped with multi-mode radios with different frequency transceivers, for example a 60 GHz transceiver, a 2.4 GHz transceiver, a 5 GHz transceiver, etc. A WCD with multi-mode radios may be able to use these modes and transfer a communication session between the multiple modes. As discussed in greater detail below, a system and/or method may be used to enable session transfer between multiple frequency bands in a network with multi-mode radios.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with seamlessly supporting data flows over multiple networks using different radio protocols. According to one aspect, a method for seamlessly supporting data flows over multiple networks using different radio protocols is provided. The method can comprise supporting a data flow over a wireless link using a first radio protocol. Further, the method can comprise enabling a second radio protocol for the data flow, based on one or more parameters. Still further, the method can comprise selecting at least one of the first radio protocol or the second radio protocol to support the data flow over the wireless link, while maintaining the data flow over the wireless link. Moreover, the method can comprise communicating the data flow over the wireless link using the selected at least one of the first radio protocol or the second radio protocol.

Another aspect relates to a computer program product comprising a computer-readable medium. The computer-readable medium comprising code executable to support a data flow over a wireless link using a first radio protocol. Further, the computer-readable medium comprises code executable to enable a second radio protocol for the data flow, based on one or more parameters. Still further, the computer-readable medium comprises code executable to select at least one of the first radio protocol or the second radio protocol to support the data flow over the wireless link, while maintaining the data flow over the wireless link. More over, the computer-readable medium comprises code executable to communicate the data flow over the wireless link using the selected at least one of the first radio protocol or the second radio protocol.

Yet another aspect relates to an apparatus. The apparatus can comprise means for supporting a data flow over a wireless link using a first radio protocol. Further, the apparatus can comprise means for enabling a second radio protocol for the data flow, based on one or more parameters. Still further, the apparatus can comprise means for selecting at least one of the first radio protocol or the second radio protocol to support the data flow over the wireless link, while maintaining the data flow over the wireless link. Moreover, the apparatus can comprise means for communicating the data flow over the wireless link using the selected at least one of the first radio protocol or the second radio protocol.

Another aspect relates to a station. The station can include an antenna. Further, the station can include a processing system coupled to the antenna, configured to: support a data flow over a wireless link using a first radio protocol, enable a second radio protocol for the data flow, based on one or more parameters, select at least one of the first radio protocol or the second radio protocol to support the data flow over the wireless link, while maintaining the data flow over the wireless link, and communicate the data flow over the wireless link using the selected at least one of the first radio protocol or the second radio protocol.

Another aspect relates to an apparatus. The apparatus can include a processing system configured to: support a data flow over a wireless link using a first radio protocol, enable a second radio protocol for the data flow, based on one or more parameters, select at least one of the first radio protocol or the second radio protocol to support the data flow over the wireless link, while maintaining the data flow over the wireless link, and a transmitter configured to communicate the data flow over the wireless link using the selected at least one of the first radio protocol or the second radio protocol.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

These and other sample aspects of the invention will be described in the detailed description that follow, and in the accompanying drawings, wherein:

FIG. 1 illustrates a block diagram of a communication network according to an aspect;

FIG. 2 is a flowchart of an aspect of a communication network depicting assisting in discovery of a directional communications network using an omni-directional communications network;

FIG. 3 illustrates a block diagram of multiple layers including a MAC layer and PHY layer according to an aspect;

FIG. 4 illustrates a block diagram example architecture of a wireless communications device;

FIG. 5 illustrates another block diagram example architecture of a wireless node;

FIG. 6 illustrates a conceptual diagram illustrating an example of a hardware configuration for a processing system in a wireless node; and

FIG. 7 is a conceptual block diagram illustrating the functionality of an example apparatus.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of methods and apparatus are described more fully hereinafter with reference to the accompanying drawings. These methods and apparatus may, however, be embodied in many different forms and should not be construed as limited to any specific structure or function presented throughout this disclosure. Rather, these aspects are provided so that this disclosure will be thorough and complete, and will fully convey the scope of these methods and apparatus to those skilled in the art.

Based on the descriptions and teaches herein one skilled in the art should appreciate that that the scope of the disclosure is intended to cover any aspect of the methods and apparatus disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure herein may be embodied by one or more elements of a claim.

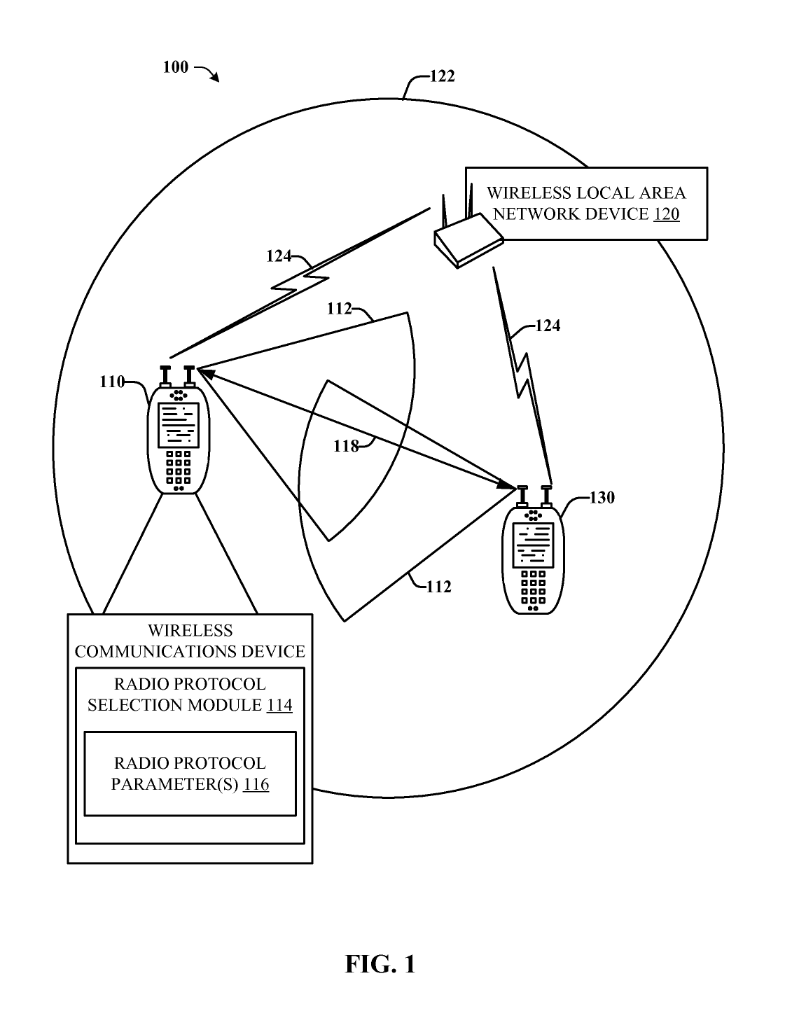

Several aspects of a wireless network will now be presented with reference to FIG. 1. The wireless communication system 100 is shown with several wireless access terminals, generally designated as access terminals 110 and 130, a wireless network device 120, generally a WLAN device, a base station, etc., wherein the several access terminals 110, 130 may communicate using multiple protocols 118, 124 associated with multiple networks 112, 122. As used herein, a wireless node 110, 130 may be referred to as a WCD, user equipment (UE), a laptop, etc. Each wireless node is capable of receiving and/or transmitting. In the detailed description that follows, the term “access point” is used to designate a transmitting node and the term “access terminal” is used to designate a receiving node for downlink communications, whereas the term “access point” is used to designate a receiving node and the term “access terminal” is used to designate a transmitting node for uplink communications. However, those skilled in the art will readily understand that other terminology or nomenclature may be used for an access point and/or access terminal. By way of example, an access point may be referred to as a base station, a base transceiver station, a station, a terminal, a node, an access terminal acting as an access point, a WLAN device, or some other suitable terminology. An access terminal may be referred to as a user terminal, a mobile station, a subscriber station, a station, a wireless device, a terminal, a node, or some other suitable terminology. The various concepts described throughout this disclosure are intended to apply to all suitable wireless access terminals regardless of their specific nomenclature.

The wireless communication system 100 may support access terminals distributed throughout a geographic region. Connectivity assistance system 120 may be used to provide coordination and control of the access terminals, as well as access to other networks (e.g., Internet). An access terminal, which may be fixed or mobile, may use backhaul services of an access point or engage in peer-to-peer communications with other access terminals. Examples of access terminals include a telephone (e.g., cellular telephone), a laptop computer, a desktop computer, a Personal Digital Assistant (PDA), a digital audio player (e.g., MP3 player), a camera, a game console, or any other suitable wireless node.

Generally, an established data flow may be supported between access terminal 110 and access terminal 130 using a first protocol 124 which may be omni-directional 122 and may use a relatively low frequency for communications (e.g., 2.4 GHz, 5 GHz, etc.). Further, a data flow may include a machine access control (MAC) or higher layer data interchange that may be set up following an association and/or authentication process. As used herein, maintaining a data flow over a wireless link may include continuing the data interchange without a sufficiently large time gap which may result in re-association and/or re-authentication. Still further, access terminals 110 and 130 may be equipped with multi-mode radios, with access to at least a first lower frequency through a first radio protocol and a second higher frequency (e.g., 60 GHz) through a second radio protocol. In one aspect of WCD 110, radio protocol selection module 114 may analyze one or more radio protocol parameters 116 to determine whether a supported communication session is communicated over one or multiple radio protocols. In one aspect, a second higher frequency may have a comparatively shorter range but higher maximum throughput than a first lower frequency. In such an aspect, transfer to a session using the second higher frequency may be preferable when link conditions are satisfactory in the second higher frequency. Conversely, where conditions are not satisfactory for a high through-put communication, it may be preferable to transfer a session from a second higher frequency to a first lower frequency. Further, where conditions are satisfactory for both the first and second frequencies, it may be preferable to support a session using both frequencies, thereby increasing through-put.

In one aspect, radio protocol parameters 116 may include, but are limited to: radio link quality for at least one frequency associated with at least one of the first radio protocol or the second radio protocol, round trip delay value for at least one frequency associated with at least one of the first radio protocol or the second radio protocol, network loading for at least one of a network supported by the first radio protocol or a network supported by the second radio protocol, quality of service associated with at least one of the first radio protocol or the second radio protocol, etc. In such an aspect, the quality of service metric may include values such as, a latency value, a data rate value, an error rate value, etc. In one aspect, at least one of the first or second radio protocols may include use of request to send (RTS) and clear to send (CTS) messages. In such an aspect, the round trip delay value may be determined using the departure time of the RTS message and the arrival time of the CTS message. In another aspect, at least one of the first or second radio protocols may include use of a probe message and an acknowledgment (ACK) message. In such an aspect, the round trip delay value may be determined using the departure time of a probe message and the arrival time of an ACK message. As noted above, radio protocol selection module 114 may determine which of multiple protocols may be used for communication of a data flow based on one or more parameters 116. Such determinations may be made through, for example, comparing at least one of the one or more parameters for the second radio protocol with a corresponding parameter for the first radio protocol. In another aspect, a determination may be made through, for example, comparing at least one of the one or more parameters for the second radio protocol with a threshold value. In yet another aspect, such a determination may be made through, for example, comparing at least one of the one or more parameters for the first radio protocol with a threshold value.

In such example aspects, the first protocol may include, wireless local area network based protocol, a cellular network protocol, and a Bluetooth based protocol, etc. In another aspect, the second radio protocol may include a wireless network protocol for operation in a 60 GHz and higher frequency bands, a wireless local area network, a cellular network protocol, an IEEE 802.11 protocol.

The wireless communication system 100 may support MIMO technology. Using MIMO technology, multiple access terminals 110 may communicate simultaneously using Spatial Division Multiple Access (SDMA). SDMA is a multiple access scheme which enables multiple streams transmitted to different receivers at the same time to share the same frequency channel, or communicate using different frequencies, and, as a result, provide higher user capacity. This is achieved by spatially precoding each data stream and then transmitting each spatially precoded stream through a different transmit antenna on the downlink. The spatially precoded data streams arrive at the access terminals with different spatial signatures, which enables each access terminal 110, 130 to recover the data stream destined for that access terminal 110, 130. On the uplink, each access terminal 110, 130 transmits a spatially precoded data stream, which enables the identity of the source of each spatially precoded data stream to be known.

One or more access terminals 110 may be equipped with multiple antennas to enable certain functionality. With this configuration, multiple antennas at the access terminal 110 may be used to communicate to improve data throughput without additional bandwidth or transmit power. This may be achieved by splitting a high data rate signal at the transmitter into multiple lower rate data streams with different spatial signatures, thus enabling the receiver to separate these streams into multiple channels and properly combine the streams to recover the high rate data signal.

While portions of the following disclosure will describe access terminals that also support MIMO technology, the access terminal 110 may also be configured to support access terminals that do not support MIMO technology. This approach may allow older versions of access terminals (i.e., “legacy” terminals) to remain deployed in a wireless network, extending their useful lifetime, while allowing newer MIMO access terminals to be introduced as appropriate.

In the detailed description that follows, various aspects of the disclosure will be described with reference to a MIMO system supporting any suitable wireless technology, such as Orthogonal Frequency Division Multiplexing (OFDM). OFDM is a spread-spectrum technique that distributes data over a number of subcarriers spaced apart at precise frequencies. The spacing provides “orthogonality” that enables a receiver to recover the data from the subcarriers. An OFDM system may implement IEEE 802.11, or some other air interface standard. Other suitable wireless technologies include, by way of example, Code Division Multiple Access (CDMA), Time Division Multiple Access (TDMA), or any other suitable wireless technology, or any combination of suitable wireless technologies. A CDMA system may implement with IS-2000, IS-95, IS-856, Wideband-CDMA (WCDMA), or some other suitable air interface standard. A TDMA system may implement Global System for Mobile Communications (GSM) or some other suitable air interface standard. As those skilled in the art will readily appreciate, the various aspects of this invention are not limited to any particular wireless technology and/or air interface standard.

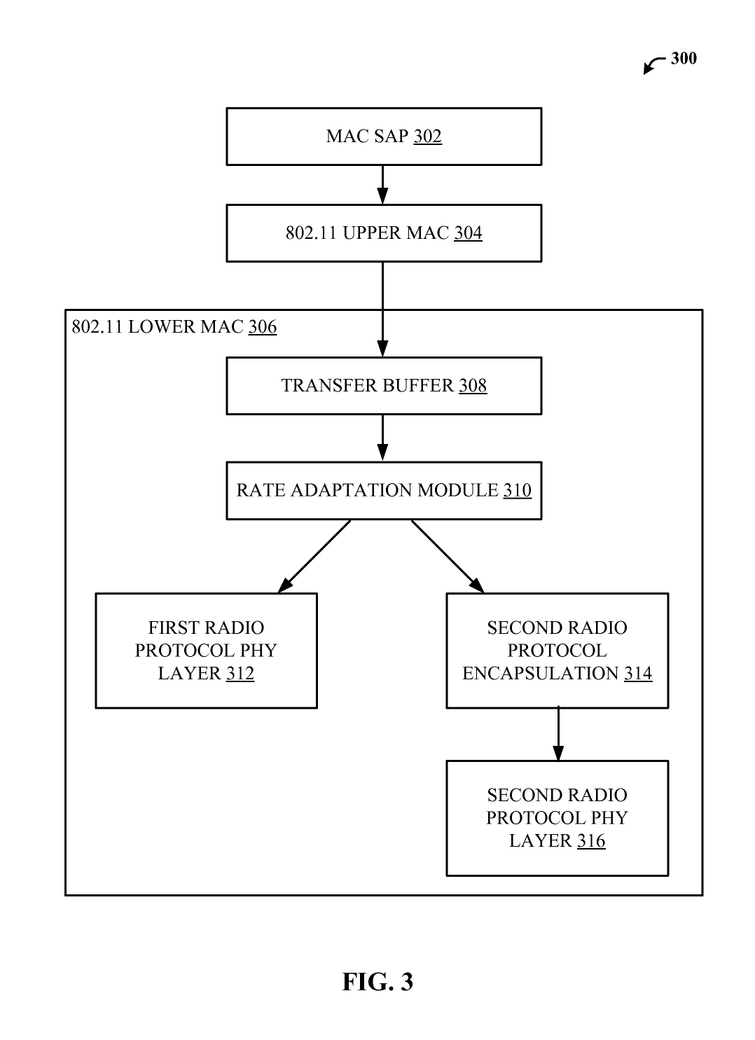

The wireless node (e.g., 110, 130), whether an access point or access terminal, may be implemented with a protocol that utilizes a layered structure that includes a physical (PHY) layer that implements all the physical and electrical specifications to interface the wireless node to the shared wireless channel, a MAC layer that coordinates access to the shared wireless channel, and an application layer that performs various data processing functions including, by way of example, speech and multimedia codecs and graphics processing. Further discussion of the MAC and PHY layers is provided with reference to FIG. 3. Additional protocol layers (e.g., network layer, transport layer) may be required for any particular application. In some configurations, the wireless node may act as a relay point between an access point and access terminal, or two access terminals, and therefore, may not require an application layer. Those skilled in the art will be readily able to implement the appropriate protocol for any wireless node depending on the particular application and the overall design constraints imposed on the overall system.

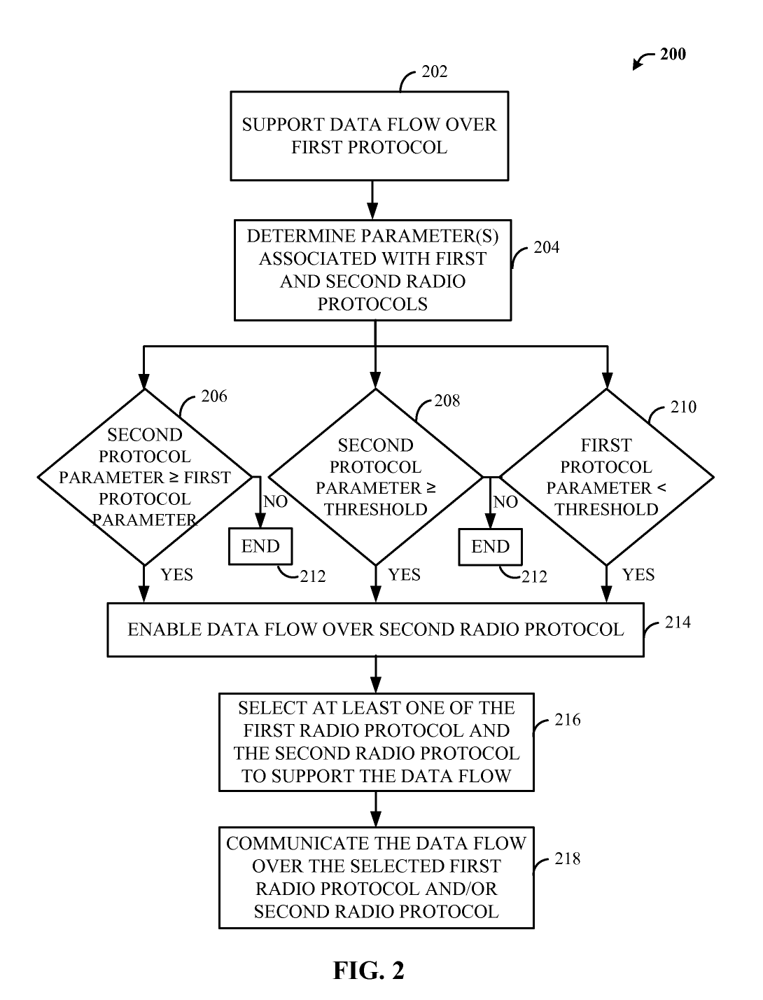

FIG. 2 illustrates various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring to FIG. 2, a wireless node may seamlessly support data flows over multiple networks using different radio protocols. At reference numeral 202, a data flow is supported over a first radio protocol. In one aspect, this first radio protocol may be omni-directional, may communicate is comparatively lower frequencies (e.g., 2.4 GHz, 5 GHz, etc.), may provide a comparatively larger coverage region and may communicate at a comparatively lower transmit rate than a second radio protocol. In such aspect, a multi-mode device may seek to support the established communication session using one or more available modes. At reference numeral 204, one or more parameters associated with at least one of a first and second radio protocol associated with a multi-mode device are determined. In one aspect, the one or more parameters may include, but are limited to: radio link quality for at least one frequency associated with at least one of the first radio protocol or the second radio protocol, network loading for at least one of a network supported by the first radio protocol or a network supported by the second radio protocol, quality of service associated with at least one of the first radio protocol or the second radio protocol, etc. In such an aspect, the quality of service metric may include values such as, a latency value, a data rate value, an error rate value, etc. In another such aspect, radio link quality may be estimated through a path loss model. In another aspect, radio link quality may be estimated using a round trip delay time.

Reference numerals 206, 207 and 208 provide example triggering events which may prompt a multi-mode device to modify the transmission mode upon which the current data flow is being supported. At reference numeral 206, a comparison is made between a parameter associated with the second radio protocol and the corresponding parameter associated with the first radio protocol. In one aspect, a threshold value may be included in the comparison to reduce frequency of transmission mode modifications. Additionally, or in the alternative, at reference numeral 208, a comparison may be made between a parameter associated with the second radio protocol and a threshold value. Further additionally, or in the alternative, at reference numeral 210, a comparison is made between a parameter associated with the first radio protocol and a threshold value. Upon a negative determination from an applicable comparison, as depicted in reference numerals 206, 208, and/or 208, at reference numeral 212, a process for providing additional modes to support an established data flow may end. By contrast, upon a positive determination from an applicable comparison, as depicted in reference numerals 206, 208, and/or 208, at reference numeral 214, data flow may be enabled over a second radio protocol. In such an aspect, an established communication session may remain uninterrupted by the enabling of the second radio protocol. In one aspect, enabling a second radio protocol may include beam training. In such an aspect, beam training may include: transmission of a training pilot by each device through one or more beam directions, reception of one or more transmitted training beam at each device, determining a preferred communication beam direction based on signal strength values from the one or more received training beams, and exchanging the preferred communication beam direction between the devices, such as through feedback, acknowledgement messages.

At reference numeral 216, at least one of the first radio protocol and/or second radio protocol are selected to support to established communication session without interrupting the data flow. In other words, the data flows communicated over the communication session may be blind to the radio protocol over which they are communicated. A block diagram of the layer structure associated with this selection process is provided with reference to FIG. 3. In one aspect, only the second, higher frequency greater through put, radio protocol may be selected. In another aspect, both the first and second radio protocols may be selected, thereby further increasing through put capabilities. In yet another aspect, only a first, lower frequency larger large, radio protocol may be selected. At reference numeral 218, data flows may be communicated over the one or more selected radio protocols. A session transfer command may be provided to prompt the device which one or more radio protocols to use to support the established communication session. In one aspect, communications using multiple radio protocols may be done as part of a single communication session. In another aspect, multiple communication sessions may be transmitted over the multiple radio protocols.

With reference to FIG. 3, an example block diagram 300 of an interaction between multiple layers is depicted. The multiple layers 300 include a MAC service access point (SAP) 302 in coupled to an 801.11 MAC layer. As depicted in FIG. 3, the MAC layer may be divided into an 802.11 upper MAC 304 and an 802.11 lower MAC 306. Further a transmit buffer 308 may be coupled to the 802.11 upper MAC 304 and a rate adaptation module 310. In one aspect, rate adaptation module 310 may determine which radio protocol PHY layer may be used. As discussed above with reference to FIG. 2, multiple parameters may be assessed in making such a determination. In one aspect, the parameters may include, but are limited to: radio link quality for at least one frequency associated with at least one of the first radio protocol or the second radio protocol, network loading for at least one of a network supported by the first radio protocol or a network supported by the second radio protocol, quality of service associated with at least one of the first radio protocol or the second radio protocol, etc. In such an aspect, the quality of service metric may include values such as, a latency value, a data rate value, an error rate value, etc. In another such aspect, radio link quality may be estimated through a path loss model. Further, in one aspect, a first protocol may be omni-directional 122 and may use a relatively low frequency for communications (e.g., 2.4 GHz, 5 GHz, etc.); while a second radio protocol may be directionally based and may use a relatively high frequency (e.g., 60 GHz) for communications. In another aspect, the second radio protocol may include a wireless network protocol for operation in a 60 GHz and higher frequency bands, a wireless local area network, a cellular network protocol, an IEEE 802.11 protocol.

In one aspect, rate adaptation module 310 may select to communicate data flows using a first radio protocol PHY layer 312. In another aspect, rate adaptation module 310 may select to communicate data flows using a second radio protocol PHY layer 316. In such an aspect, additional encapsulation 314 and/or processing may be used to allow data flows over the second radio protocol.

As such, communications maintained at or above the MAC SAP 302 may not be aware of any PHY layer and/or MAC layer processes and, as such, may maintain a consist wireless link for data flow through transitions between multiple radio protocols.

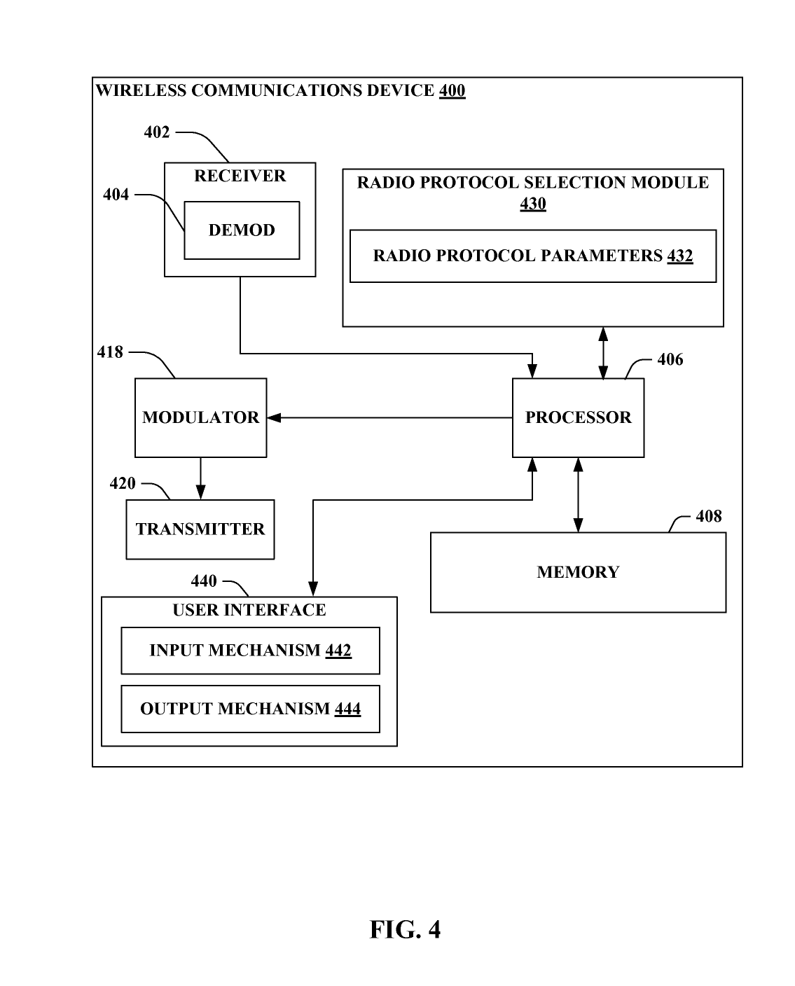

While still referencing FIG. 1, but turning also now to FIG. 4, an example architecture of wireless communications device 110 is illustrated. As depicted in FIG. 4, wireless communications device 400 comprises receiver 402 that receives a signal from, for instance, a receive antenna (not shown), performs typical actions on (e.g., filters, amplifies, downconverts, etc.) the received signal, and digitizes the conditioned signal to obtain samples. Receiver 402 can comprise a demodulator 404 that can demodulate received symbols and provide them to processor 406 for channel estimation. Further, receiver 402 may receive signals from multiple networks using multiple communication protocols. In one aspect, receiver 402 may receive a signal from a network using at least one of: CDMA, WCDMA, TDMA, TD-SCDMA, UMTS, IP, GSM, LTE, WiMax, UMB, EV-DO, 802.11, BLUETOOTH, etc.

Processor 406 can be a processor dedicated to analyzing information received by receiver 402 and/or generating information for transmission by transmitter 420, a processor that controls one or more components of wireless communications device 400, and/or a processor that both analyzes information received by receiver 402, generates information for transmission by transmitter 420, and controls one or more components of wireless communications device 400.

Wireless communications device 400 can additionally comprise memory 408 that is operatively coupled to, and/or located in, processor 406 and that can store data to be transmitted, received data, information related to available channels, data associated with analyzed signal and/or interference strength, information related to an assigned channel, power, rate, or the like, and any other suitable information for estimating a channel and communicating via the channel. Memory 408 can additionally store protocols and/or algorithms associated with estimating and/or utilizing a channel (e.g., performance based, capacity based, etc.).

It will be appreciated that data store (e.g., memory 408) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 408 of the subject systems and methods may comprise, without being limited to, these and any other suitable types of memory.

Wireless communications device 400 can further include radio protocol selection module 430 to seamlessly support data flows over multiple networks using different radio protocols. Radio protocol selection module 430 may include radio protocol parameters 432. In one aspect, radio protocol parameters 432 may include, but are limited to: radio link quality for at least one frequency associated with at least one of the first radio protocol or the second radio protocol, network loading for at least one of a network supported by the first radio protocol or a network supported by the second radio protocol, quality of service associated with at least one of the first radio protocol or the second radio protocol, etc. In such an aspect, the quality of service metric may include values such as, a latency value, a data rate value, an error rate value, etc. As noted above, radio protocol selection module 430 may determine which of multiple protocols may be used for communication of a data flow based on one or more parameters 432. Such determinations may be made through, for example, comparing at least one of the one or more parameters for the second radio protocol with a corresponding parameter for the first radio protocol. In another aspect, a determination may be made through, for example, comparing at least one of the one or more parameters for the second radio protocol with a threshold value. In yet another aspect, such a determination may be made through, for example, comparing at least one of the one or more parameters for the first radio protocol with a threshold value. In such example aspects, the first protocol may include, wireless local area network based protocol, a cellular network protocol, and a Bluetooth based protocol, etc. In another aspect, the second radio protocol may include a wireless network protocol for operation in a 60 GHz and higher frequency bands, a wireless local area network, a cellular network protocol, an IEEE 802.11 protocol.

Additionally, wireless communications device 400 may include user interface 440. User interface 440 may include input mechanisms 442 for generating inputs into communications device 400, and output mechanism 444 for generating information for consumption by the user of the communications device 400. For example, input mechanism 442 may include a mechanism such as a key or keyboard, a mouse, a touch-screen display, a microphone, etc. Further, for example, output mechanism 444 may include a display, an audio speaker, a haptic feedback mechanism, a Personal Area Network (PAN) transceiver etc. In the illustrated aspects, the output mechanism 444 may include a display operable to present media content that is in image or video format or an audio speaker to present media content that is in an audio format.

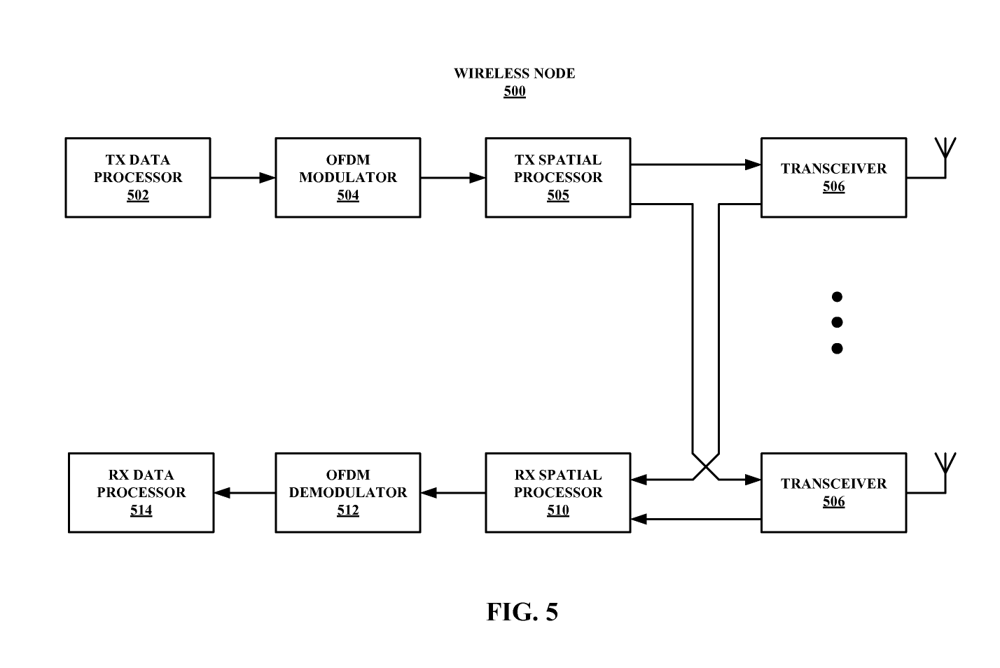

FIG. 5 is a conceptual block diagram illustrating an example of the signal processing functions of the PHY layer. In a transmit mode, a TX data processor 502 may be used to receive data from the MAC layer and encode (e.g., Turbo code) the data to facilitate forward error correction (FEC) at the receiving node. The encoding process results in a sequence of code symbols that that may be blocked together and mapped to a signal constellation by the TX data processor 502 to produce a sequence of modulation symbols.

In wireless access terminals implementing OFDM, the modulation symbols from the TX data processor 502 may be provided to an OFDM modulator 504. The OFDM modulator splits the modulation symbols into parallel streams. Each stream is then mapped to an OFDM subcarrier and then combined together using an Inverse Fast Fourier Transform (IFFT) to produce a time domain OFDM stream.

A TX spatial processor 505 performs spatial processing on the OFDM stream. This may be accomplished by spatially precoding each OFDM and then providing each spatially precoded stream to a different antenna 508 via a transceiver 506. Each transmitter 506 modulates an RF carrier with a respective precoded stream for transmission over the wireless channel.

In a receive mode, each transceiver 506 receives a signal through its respective antenna 508. Each transceiver 506 may be used to recover the information modulated onto an RF carrier and provide the information to a RX spatial processor 510.

The RX spatial processor 510 performs spatial processing on the information to recover any spatial streams destined for the wireless node 500. The spatial processing may be performed in accordance with Channel Correlation Matrix Inversion (CCMI), Minimum Mean Square Error (MMSE), Soft Interference Cancellation (SIC), or some other suitable technique. If multiple spatial streams are destined for the wireless node 500, they may be combined by the RX spatial processor 510.

In wireless access terminals implementing OFDM, the stream (or combined stream) from the RX spatial processor 510 is provided to an OFDM demodulator 512. The OFDM demodulator 512 converts the stream (or combined stream) from time-domain to the frequency domain using a Fast Fourier Transform (FFT). The frequency domain signal comprises a separate stream for each subcarrier of the OFDM signal. The OFDM demodulator 512 recovers the data (i.e., modulation symbols) carried on each subcarrier and multiplexes the data into a stream of modulation symbols.

A RX data processor 514 may be used to translate the modulation symbols back to the correct point in the signal constellation. Because of noise and other disturbances in the wireless channel, the modulation symbols may not correspond to an exact location of a point in the original signal constellation. The RX data processor 514 detects which modulation symbol was most likely transmitted by finding the smallest distance between the received point and the location of a valid symbol in the signal constellation. These soft decisions may be used, in the case of Turbo codes, for example, to compute a Log-Likelihood Ratio (LLR) of the code symbols associated with the given modulation symbols. The RX data processor 514 then uses the sequence of code symbol LLRs in order to decode the data that was originally transmitted before providing the data to the MAC layer.

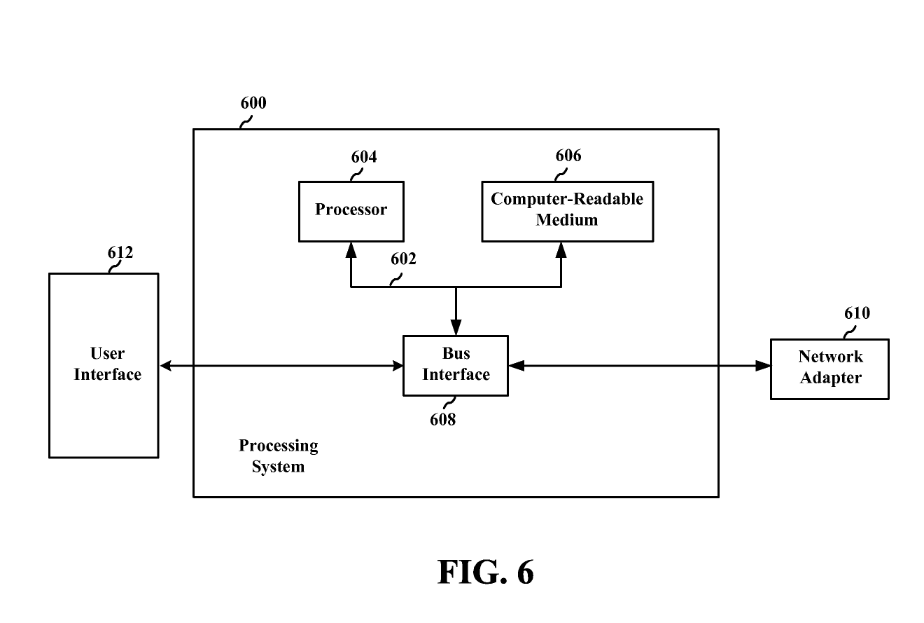

FIG. 6 is a conceptual diagram illustrating an example of a hardware configuration for a processing system in a wireless node. In this example, the processing system 600 may be implemented with a bus architecture represented generally by bus 602. The bus 602 may include any number of interconnecting buses and bridges depending on the specific application of the processing system 600 and the overall design constraints. The bus links together various circuits including a processor 604, computer-readable media 606, and a bus interface 608. The bus interface 608 may be used to connect a network adapter 610, among other things, to the processing system 600 via the bus 602. The network interface 610 may be used to implement the signal processing functions of the PHY layer. In the case of an access terminal 110 (see FIG. 1), a user interface 612 (e.g., keypad, display, mouse, joystick, etc.) may also be connected to the bus via the bus interface 608. The bus 602 may also link various other circuits such as timing sources, peripherals, voltage regulators, power management circuits, and the like, which are well known in the art, and therefore, will not be described any further.

The processor 604 is responsible for managing the bus and general processing, including the execution of software stored on the computer-readable media 608. The processor 608 may be implemented with one or more general-purpose and/or special-purpose processors. Examples include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. A computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, a carrier wave, a transmission line, or any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials.

In the hardware implementation illustrated in FIG. 6, the computer-readable media 606 is shown as part of the processing system 600 separate from the processor 604. However, as those skilled in the art will readily appreciate, the computer-readable media 606, or any portion thereof, may be external to the processing system 600. By way of example, the computer-readable media 606 may include a transmission line, a carrier wave modulated by data, and/or a computer product separate from the wireless node, all which may be accessed by the processor 604 through the bus interface 608. Alternatively, or in addition to, the computer readable media 604, or any portion thereof, may be integrated into the processor 604, such as the case may be with cache and/or general register files.

The processing system, or any part of the processing system, may provide the means for performing the functions recited herein. By way of example, the processing system executing code may provide the means for supporting a data flow over a wireless link using a first radio protocol, means for enabling a second radio protocol for the data flow, based on one or more parameters, means for selecting at least one of the first radio protocol or the second radio protocol to support the data flow over the wireless link, while maintaining the wireless link, and means for communicating the data flow over the wireless link using the selected at least one of the first radio protocol or the second radio protocol. Alternatively, the code on the computer-readable medium may provide the means for performing the functions recited herein.

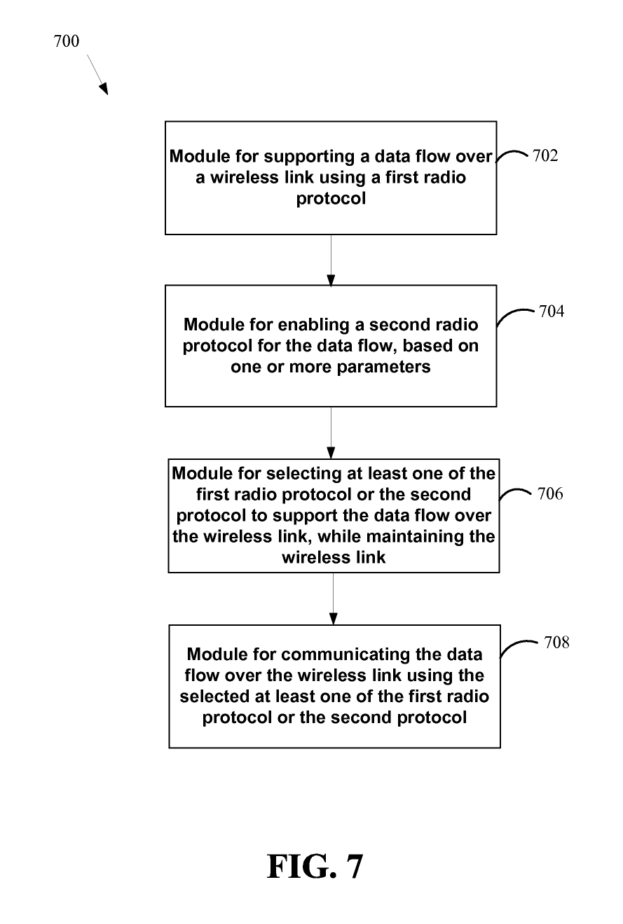

FIG. 7 is a conceptual block diagram 700 illustrating the functionality of an example apparatus 600. The apparatus 600 includes a module 702 that supports a data flow over a wireless link using a first radio protocol, a module 704 that enables a second radio protocol for the data flow, based on one or more parameters, a module 706 that selects at least one of the first radio protocol or the second radio protocol to support the data flow over the wireless link, while maintaining the wireless link, and a module 708 that communicates the data flow over the wireless link using the selected at least one of the first radio protocol or the second radio protocol.

Referring to FIG. 1 and FIG. 6, in one configuration, the apparatus 600 for wireless communication includes means for supporting a data flow over a wireless link using a first radio protocol, means for enabling a second radio protocol for the data flow, based on one or more parameters, means for selecting at least one of the first radio protocol or the second radio protocol to support the data flow over the wireless link, while maintaining the data flow over the wireless link, and means for communicating the data flow over the wireless link using the selected at least one of the first radio protocol or the second radio protocol. In one aspect, the means for supporting a data flow over a wireless link using a first radio protocol may include a processor (e.g., 406, 604). In another aspect, the means for enabling a second radio protocol for the data flow, based on one or more parameters, may include a processor (e.g., 406, 604). In still another aspect, the means for selecting at least one of the first radio protocol or the second radio protocol to support the data flow over the wireless link, while maintaining the data flow over the wireless link, may include a processor (e.g., 406, 604). In yet another aspect, the means for communicating the data flow over the wireless link using the selected at least one of the first radio protocol or the second radio protocol may include a transceiver (e.g., 506).

In another configuration, the apparatus 600 for wireless communication includes means for using both of the first radio protocol and the second radio protocol. In another configuration, the apparatus 600 for wireless communication includes means for performing beam training to establish a communication path using the second radio protocol. In another configuration, the apparatus 600 for wireless communication includes means for comparing at least one of the one or more parameters for the second radio protocol with a corresponding parameter for the first radio protocol, and means for enabling the second radio protocol if the at least one of the one or more parameters for the second radio protocol is greater than or equal to the corresponding parameter for the first radio protocol by a threshold value. In such a configuration, the apparatus 600 for wireless communication includes means for communicating the data flow over the wireless link using the enabled second radio protocol. In another configuration, the apparatus 600 for wireless communication includes means for comparing at least one of the one or more parameters for the second radio protocol with a threshold value, and means for enabling the second radio protocol if the at least one of the one or more parameters for the second radio protocol is greater than or equal to the threshold value. In such a configuration, the apparatus 600 for wireless communication includes means for communicating the data flow over the wireless link using the enabled second radio protocol. In another configuration, the apparatus 600 for wireless communication includes means for comparing at least one of the one or more parameters for the first radio protocol with a threshold value, and means for enabling the second radio protocol if the at least one of the one or more parameters for the first radio protocol is less than the threshold value. In such a configuration, the apparatus 600 for wireless communication includes means for communicating the data flow over the wireless link using the enabled second radio protocol. The aforementioned means is the processing system 600 configured to perform the functions recited by the aforementioned means. As described supra, the processing system 600 includes the TX Processor 502, the RX Processor 514, and processors 505 and 510. As such, in one configuration, the aforementioned means may be the TX Processor 502, the RX Processor 514, and processors 505 and 510 configured to perform the functions recited by the aforementioned means.

Those skilled in the art will recognize how best to implement the described functionality presented throughout this disclosure depending on the particular application and the overall design constraints imposed on the overall system.

It is understood that any specific order or hierarchy of steps described in the context of a software module is being presented to provide an examples of a wireless node. Based upon design preferences, it is understood that the specific order or hierarchy of steps may be rearranged while remaining within the scope of the invention.

The previous description is provided to enable any person skilled in the art to fully understand the full scope of the disclosure. Modifications to the various configurations disclosed herein will be readily apparent to those skilled in the art. Thus, the claims are not intended to be limited to the various aspects of the disclosure described herein, but is to be accorded the full scope consistent with the language of claims, wherein reference to an element in the singular is not intended to mean “one and only one” unless specifically so stated, but rather “one or more.” Unless specifically stated otherwise, the term “some” refers to one or more. A claim that recites at least one of a combination of elements (e.g., “at least one of A, B, or C”) refers to one or more of the recited elements (e.g., A, or B, or C, or any combination thereof). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

1. A method of wireless communications, the method comprising:
supporting a data flow over a wireless link using a first radio protocol;
enabling a second radio protocol for the data flow, based on one or more parameters;
selecting at least one of the first radio protocol or the second radio protocol to support the data flow over the wireless link, while maintaining the data flow over the wireless link; and
communicating the data flow over the wireless link using the selected at least one of the first radio protocol or the second radio protocol.

2. The method of claim 1, wherein the communication of the data flow comprises using both of the first radio protocol and the second radio protocol.

3. The method of claim 1, wherein enablement of the second radio protocol comprises performing beam training to establish a communication path using the second radio protocol.

4. The method of claim 1, wherein the one or more parameters comprise at least one of:
radio link quality for at least one frequency associated with at least one of the first radio protocol or the second radio protocol;
network loading for at least one of a network supported by the first radio protocol or a network supported by the second radio protocol;
quality of service associated with at least one of the first radio protocol or the second radio protocol; or
a round trip delay time for at least one frequency associated with at least one of the first radio protocol or the second radio protocol.

5. The method of claim 4, wherein the quality of service comprises at least one of:
a latency value, a data rate value, or an error rate value.

6. The method of claim 4, wherein the round trip delay time is measured using a departure time of a request to send message and an arrival time of a clear to send message.

7. The method of claim 4, wherein the round trip delay time is measured using a departure of a probe message and an arrival time of an acknowledgement message.

8. The method of claim 1, wherein the enablement of the second radio protocol comprises:
comparing at least one of the one or more parameters for the second radio protocol with a corresponding parameter for the first radio protocol; and
enabling the second radio protocol if the at least one of the one or more parameters for the second radio protocol is greater than or equal to the corresponding parameter for the first radio protocol by a threshold value.

9. The method of claim 8, wherein the communication of the data flow further comprises communicating the data flow over the wireless link using the enabled second radio protocol.

10. The method of claim 1, wherein the enablement of the second radio protocol comprises:
comparing at least one of the one or more parameters for the second radio protocol with a threshold value; and
enabling the second radio protocol if the at least one of the one or more parameters for the second radio protocol is greater than or equal to the threshold value.

11. The method of claim 10, wherein the communication of the data flow further comprises communicating the data flow over the wireless link using the enabled second radio protocol.

12. The method of claim 1, wherein the enablement of the second radio protocol comprises:
comparing at least one of the one or more parameters for the first radio protocol with a threshold value; and
enabling the second radio protocol if the at least one of the one or more parameters for the first radio protocol is less than the threshold value.

13. The method of claim 12, wherein the communication of the data flow further comprises communicating the data flow over the wireless link using the enabled second radio protocol.

14. The method of claim 1, wherein the second radio protocol is capable of supporting higher data rates than the first radio protocol.

15. The method of claim 1, wherein at least one of the first protocol or the second radio protocol comprises at least one of:
a wireless network protocol for operation in a frequency band of at least 60 GHz;
a wireless local area network based protocol;
a cellular network protocol;
a Bluetooth protocol; or
an IEEE 802.11 protocol.

16. A computer program product, comprising:
a computer-readable medium comprising code executable to:
support a data flow over a wireless link using a first radio protocol;
enable a second radio protocol for the data flow, based on one or more parameters;
select at least one of the first radio protocol or the second radio protocol to support the data flow over the wireless link, while maintaining the data flow over the wireless link; and
communicate the data flow over the wireless link using the selected at least one of the first radio protocol or the second radio protocol.

17. An apparatus for wireless communications, comprising:
means for supporting a data flow over a wireless link using a first radio protocol;
means for enabling a second radio protocol for the data flow, based on one or more parameters;
means for selecting at least one of the first radio protocol or the second radio protocol to support the data flow over the wireless link, while maintaining the data flow over the wireless link; and
means for communicating the data flow over the wireless link using the selected at least one of the first radio protocol or the second radio protocol.

18. The apparatus of claim 17, wherein the means for communicating further comprise means for using both of the first radio protocol and the second radio protocol.

19. The apparatus of claim 17, wherein means for enabling further comprise means for performing beam training to establish a communication path using the second radio protocol.

20. The apparatus of claim 17, wherein the one or more parameters comprise at least one of:
a radio link quality for at least one frequency associated with at least one of the first radio protocol or the second radio protocol;
network loading for at least one of a network supported by the first radio protocol or a network supported by the second radio protocol;
quality of service associated with at least one of the first radio protocol or the second radio protocol; or
a round trip delay time for at least one frequency associated with at least one of the first radio protocol or the second radio protocol.

21. The apparatus of claim 20, wherein the quality of service comprises at least one of: a latency value, a data rate value, or an error rate value.

22. The apparatus of claim 20, wherein the round trip delay time is measured using a departure time of a request to send message and an arrival time of a clear to send message.

23. The apparatus of claim 20, wherein the round trip delay time is measured using a departure of a probe message and an arrival time of an acknowledgement message.

24. The apparatus of claim 17, wherein the means for enabling further comprise:
means for comparing at least one of the one or more parameters for the second radio protocol with a corresponding parameter for the first radio protocol; and
means for enabling the second radio protocol if the at least one of the one or more parameters for the second radio protocol is greater than or equal to the corresponding parameter for the first radio protocol by a threshold value.

25. The apparatus of claim 24, wherein the means for communicating further comprise means for communicating the data flow over the wireless link using the enabled second radio protocol.

26. The apparatus of claim 17, wherein the means for enabling further comprise:
means for comparing at least one of the one or more parameters for the second radio protocol a threshold value; and
means for enabling the second radio protocol if the at least one of the one or more parameters for the second radio protocol is greater than or equal to the threshold value.

27. The apparatus of claim 26, wherein the means for communicating further comprise means for communicating the data flow over the wireless link using the enabled second radio protocol.

28. The apparatus of claim 17, wherein the means for enabling further comprise:
means for comparing at least one of the one or more parameters for the first radio protocol with a threshold value; and
means for enabling the second radio protocol if the at least one of the one or more parameters for the first radio protocol is less than the threshold value.

29. The apparatus of claim 28, wherein the means for communicating further comprise means for communicating the data flow over the wireless link using the enabled second radio protocol.

30. The apparatus of claim 17, wherein the second radio protocol is capable of supporting higher data rates than the first radio protocol.

31. The apparatus of claim 17, wherein at least one of the first protocol or the second radio protocol comprises at least one of:
a wireless network protocol for operation in a frequency band of at least 60 GHz;
a wireless local area network based protocol;
a cellular network protocol;
a Bluetooth protocol; or
an IEEE 802.11 protocol.

32. A station, comprising:
an antenna;
a processing system coupled to the antenna, configured to:
support a data flow over a wireless link using a first radio protocol;
enable a second radio protocol for the data flow, based on one or more parameters;
select at least one of the first radio protocol or the second radio protocol to support the data flow over the wireless link, while maintaining the data flow over the wireless link; and
a transmitter configured to:
communicate the data flow over the wireless link using the selected at least one of the first radio protocol or the second radio protocol.

33. An apparatus for wireless communications, comprising:
a processing system configured to:
support a data flow over a wireless link using a first radio protocol;
enable a second radio protocol for the data flow, based on one or more parameters;
select at least one of the first radio protocol or the second radio protocol to support the data flow over the wireless link, while maintaining the data flow over the wireless link; and
a transmitter configured to:
communicate the data flow over the wireless link using the selected at least one of the first radio protocol or the second radio protocol.

34. The apparatus of claim 33, wherein the processing system is configured to use both of the first radio protocol and the second radio protocol.

35. The apparatus of claim 33, wherein the processing system is configured to perform beam training to establish a communication path using the second radio protocol.

36. The apparatus of claim 33, wherein the one or more parameters comprise at least one of:
radio link quality for at least one frequency associated with at least one of the first radio protocol or the second radio protocol;
network loading for at least one of a network supported by the first radio protocol or a network supported by the second radio protocol;
quality of service associated with at least one of the first radio protocol or the second radio protocol; or
a round trip delay time for at least one frequency associated with at least one of the first radio protocol or the second radio protocol.

37. The apparatus of claim 36, wherein the quality of service comprises at least one of: a latency value, a data rate value, or an error rate value.

38. The apparatus of claim 36, wherein the round trip delay time is measured using a departure time of a request to send message and an arrival time of a clear to send message.

39. The method of claim 36, wherein the round trip delay time is measured using a departure of a probe message and an arrival time of an acknowledgement message.

40. The apparatus of claim 33, wherein the processing system is configured to:
compare at least one of the one or more parameters for the second radio protocol with a corresponding parameter for the first radio protocol; and
enable the second radio protocol if the at least one of the one or more parameters for the second radio protocol is greater than or equal to the corresponding parameter for the first radio protocol by a threshold value.

41. The apparatus of claim 40, wherein the transmitter is further configured to communicate the data flow over the wireless link using the enabled second radio protocol.

42. The apparatus of claim 33, wherein the processing system is configured to:
compare at least one of the one or more parameters for the second radio protocol with a threshold value; and
enable the second radio protocol if the at least one of the one or more parameters for the second radio protocol is greater than or equal to the threshold value.

43. The apparatus of claim 42, wherein the transmitter is further configured to communicate the data flow over the wireless link using the enabled second radio protocol.

44. The apparatus of claim 33, wherein the processing system is configured to:
compare at least one of the one or more parameters for the first radio protocol with a threshold value; and
enable the second radio protocol if the at least one of the one or more parameters for the first radio protocol is less than the threshold value.

45. The apparatus of claim 44, wherein the transmitter is further configured to communicate the data flow over the wireless link using the enabled second radio protocol.

46. The apparatus of claim 33, wherein the second radio protocol is capable of supporting higher data rates than the first radio protocol.

47. The apparatus of claim 33, wherein at least one of the first protocol or the second radio protocol comprises at least one of:
a wireless network protocol for operation in a frequency band of at least 60 GHz;
a wireless local area network based protocol;
a cellular network protocol;
a Bluetooth protocol; or
an IEEE 802.11 protocol.
